(19) United States
(12) Patent Application Publication
(10) Pub. No.: US 2008/0199590 A1
(43) Pub. Date: Aug. 21, 2008

(54) LOW TRANS FATTY ACID SHORTENING COMPOSITIONS

(76) Inventors: Frank R. Kincs, Bourbonnais, IL (US); Rey G. Cruz, Bourbonnais, IL (US)

Correspondence Address: MCANDREWS HELD & MALLOY, LTD, 500 WEST MADISON STREET, SUITE 3400, CHICAGO, IL, 60661, US

(21) Appl. No.: 11/675,959

(22) Filed: Feb. 16, 2007

(51) Int. Cl. A23D 9/007

(52) U.S. Cl. 426/606

(57) ABSTRACT

Interesterified or blended shortening compositions having a relatively low proportion of trans fatty acid are described. The shortening compositions are made by blending or interesterifying low-linolenic soybean oil, including from 1 to 3.5 wt. % linolenic fatty acid moieties and from 0 to 2 wt. % trans fatty acid moieties, and a highly saturated fat including from 0 to 2 wt. % of trans fatty acid moieties. The interesterified or blended shortening composition has a trans-fatty acid moiety content of from 0 to 2 wt. %. These interesterified or simple blends are low in trans fatty acid, but are otherwise similar in composition and performance to partially hydrogenated vegetable oils. Products made from the compositions include baked goods, such as short bread cookies, biscuits, pie crusts, or puff pastry shells, or an icing such as cream icing.

### BACKGROUND OF THE INVENTION

A problem addressed by certain embodiments of this invention is how to make the equivalent of a partially hydrogenated vegetable shortening composition having reduced trans fatty acid content, as well as a relatively high melting temperature range and oxidative stability and relatively low saturated fat content.

Shortening is a fundamental ingredient of baked goods, fried foods, icing, and other foods. Traditional shortenings are predominantly composed of fat or oil. Fats and oils have the same general structure but are in different physical states: An oil is in the liquid state, and a fat is in the solid state.

Chemically, fats and oils are mixtures predominantly composed of triglycerides. A triglyceride molecule is composed of a glycerol moiety and three fatty acid moieties. A fatty acid can be saturated or unsaturated; an unsaturated fatty acid contains one or more double bonds in its hydrocarbon chain, while a saturated fatty acid does not. Triglycerides can also be saturated, if composed of three fully saturated fatty acid moieties per molecule, or unsaturated, if composed of one or more unsaturated fatty acid moieties.

The degree of saturation of a bulk oil or a bulk fatty acid is the average degree of saturation of its constituent glycerides. A fat, oil, or fatty acid having an average of one site of unsaturation per fatty acid moiety is sometimes referred to as monounsaturated, one having more than one site of unsaturation per fatty acid moiety is sometimes referred to as polyunsaturated, and one that has been modified to reduce its natural unsaturation can be fully saturated or partially saturated.

The double bonds of unsaturated fatty acids can be “cis” or “trans” double bonds. In the “cis” isomer, the two hydrogen atoms bonded directly to the respective carbon atoms of the double bond are located on the same side of the double bond—the “lower” side as shown in the following structure:

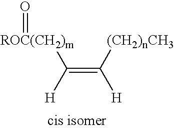

In the “trans” isomer, the two hydrogen atoms bonded directly to the respective carbon atoms of the double bond are located on the opposite sides of the double bond—one “above” and the other “below,” as shown in the following structure:

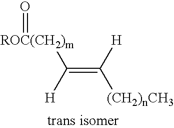

The trans isomer is also referred to as a trans fatty acid.

Saturated fat and trans fatty acid are now regarded as undesirable constituents that must be identified on food labels in the United States.

Traditional animal-derived shortenings such as lard or tallow are predominantly saturated oil. Animal shortening in its native state contains little trans fatty acid, however.

Most natural vegetable oils are less saturated than animal fats and contain essentially no trans fatty acid, and thus are regarded as healthier than lard or tallow. But natural vegetable oils melt at a low temperature and are unstable to oxidation, particularly when polyunsaturated. Most vegetable oils thus are not well suited to function as shortening in their natural state.

Hydrogenation is a chemical reaction in which some or all of the double bonds between carbon atoms are saturated by attachment of an additional pair of hydrogen atoms to the pair of carbon atoms forming the double bond. The double bond thus becomes a single bond. Hydrogenation has been used to make vegetable oils more solid and stable and to increase the quality and storage life of many foods, while providing the attributes of texture and eating quality desired by consumers in fried, baked, or processed foods.

If vegetable oil is fully hydrogenated, it becomes stable and solid, its native unsaturation is eliminated, and essentially no trans fatty acid is produced. But the resulting shortening is fully saturated fat, thus requiring disclosure of a high proportion of saturated fat on labels of foods made with the shortening.

One way to improve the properties of vegetable oils without fully hydrogenating them is to partially hydrogenate them. Partially hydrogenated oils first became popular during the 1960's and 1970's as substitutes for natural animal fats because the partially hydrogenated oils contribute the same or similar desirable characteristics to foods, but provide less saturated fat than animal fats or fully hydrogenated oils. Later, partially hydrogenated oils were also used to replace certain highly saturated vegetable oils. Partially hydrogenated vegetable oils do not easily or quickly become rancid, thus preserving their freshness and extending the shelf life of foods containing them.

But partial hydrogenation introduces trans fatty acid. The naturally selectively cis unsaturation of a natural oil is racemized as a by-product of the hydrogenation process, converting the natural cis unsaturation to a mixture of cis and trans unsaturation. Thus, the very partial hydrogenation process that makes a vegetable oil suitable as shortening, while providing less saturated fatty acid compared to fully saturated shortening, also introduces unwanted trans fatty acid.

It is desirable to reduce to the extent possible the trans fatty acid content of foods. For example, producers of baked goods are demanding shortening that contains less trans fatty acid. Various options have been suggested or tried to avoid trans fatty acids.

One approach to reduce the trans fatty acid content of shortening has been to use vegetable oils having a naturally high saturated fat content (such as palm oil, coconut oil or palm kernel oil). These oils, while lacking trans fatty acids in their natural state, are rich in undesired saturated fat.

Another approach is to use vegetable oils having a high oleic acid content as grown (such as high oleic canola, high oleic safflower, high oleic sunflower, very high oleic sunflower, and extra virgin olive oil); or vegetable oils having a low linolenic acid content (for example, TREUS™ oil, available from Bunge Oils, palm oil, coconut oil or palm kernel oil). These types of oils are more stable against oxidation than polyunsaturated oils like traditional soybean oil. However, in these options, the attribute(s) that confer stability can be variable. For example the attribute may vary because oil seed fatty acid content is susceptible to external environmental conditions either during growing or post harvest processing. Additionally, these oils are not solid at room temperature.

It would be desirable to provide an edible fat having the oxidative stability, solid form, and other benefits of partially hydrogenated oil without the drawbacks associated with partial hydrogenation. It would also be desirable to provide edible shortening having a reduced content of saturated fatty acids, compared to a saturated shortening, without an increased content of trans fat. It would also be desirable to reduce the variability generally associated with agricultural products and crop production.

The following United States patents may be of interest.
U.S. Pat. No. 6,054,167 Pelletized shortening
U.S. Pat. No. 5,993,883 Sweet dough mix
U.S. Pat. No. 5,866,187 Baking formulation containing pelletized shortening
U.S. Pat. No. 5,395,638 Reduced fat roll-in baking compositions and baked goods
U.S. Pat. No. 5,268,191 Pourable shortening containing lauric fat and method for preparing it
U.S. Pat. No. 5,254,356 Bakery goods with liquid shortening system
U.S. Pat. No. 4,961,951 Pourable shortening containing butter and method for preparing
U.S. Pat. No. 4,960,606 Microbially-stable shortening containing butter
U.S. Pat. No. 4,260,643 Triglyceride compositions

Transesterification of saturated and unsaturated glycerides is discussed generally in Kirk-Othmer Encyclopedia of Chemical Technology, 4^{th} Ed., Vol. 10, page 263.

### BRIEF SUMMARY OF THE INVENTION

One aspect of the invention is an interesterified shortening composition. The interesterified shortening composition is made by interesterifying from 60 parts to 40 parts by weight of soybean oil and from 40 parts to 60 parts by weight of a second oil. The soybean oil includes from 1 to 3.5 wt. % linolenic fatty acid moieties and from 0 to 2 wt. % trans fatty acid moieties. The second oil includes from 90 to 100 wt. % of saturated fatty acid moieties and from 0 to 2 wt. % of trans fatty acid moieties. The interesterified shortening composition has a trans-fatty acid moiety content of from 0 to 2 wt. %.

Another aspect of the invention is a complete shortening composition consisting essentially of the interesterified shortening composition described in the preceding paragraph.

Still another aspect of the invention is a product consisting essentially of the complete shortening composition described in the preceding paragraph. Several non-limiting examples of the product are a baked good, such as a short bread cookie, biscuit, pie crust, or puff pastry shell, or icing, such as cake icing or pastry icing.

Yet another aspect of the invention is a shortening blend composition including from 70 parts to 30 parts by weight of soybean oil and from 30 parts to 70 parts by weight of a second oil. The soybean oil includes from 1 to 3.5 wt. % linolenic fatty acid moieties and from 0 to 2 wt. % trans fatty acid moieties. The second oil includes from 90 to 100 wt. % of saturated fatty acid moieties and from 0 to 2 wt. % of trans fatty acid moieties. The soybean oil and second oil in the composition together have a trans-fatty acid moiety content of from 0 to 2 wt. %.

These interesterified products or simple blends take advantage of the fact that their fully saturated constituents and their unhydrogenated constituents both are low in trans fatty acid, so blends can be provided having any degree of unsaturation but little or no trans fatty acid.

Still another aspect of the invention is a complete shortening blend composition consisting essentially of any of the shortening blend compositions described in the preceding paragraphs.

Even another aspect of the invention is a product consisting essentially of a complete shortening blend composition as described in the preceding paragraphs. Several non-limiting examples of the product are a baked good, such as a short bread cookie, biscuit, pie crust, or puff pastry shell, or icing.

All proportions or percentages expressed herein are by weight unless otherwise indicated. The weight percent of each fatty acid moiety recited in the claims is expressed as the corresponding weight of a fatty acid methyl ester moiety. The basis of each weight percentage of moieties in an oil is the total weight of all fatty acid moieties in the oil, expressed as the corresponding weight of fatty acid methyl ester moieties. “Oil” and “fat” are used interchangeably here, except when the context clearly indicates otherwise.

### DETAILED DESCRIPTION OF THE INVENTION

While the invention will be described in connection with one or more embodiments, it will be understood that the invention is not limited to those embodiments. On the contrary, the invention includes all alternatives, modifications, and equivalents as may be included within the spirit and scope of the appended claims.

Certain embodiments of the invention are carried out by mixing and optionally interesterifying plural oil feedstocks, one of which is preferably a low-linolenic soybean oil, preferably essentially unhydrogenated or lightly hydrogenated, and another of which is preferably a highly saturated oil, optionally heavily hydrogenated, optionally essentially fully saturated.

The low-linolenic soy oil, being mostly or entirely unhydrogenated, has few trans unsaturation sites, and thus little or no trans fat content. The highly saturated oil, being mostly or entirely saturated, has few (if any) unsaturation sites of either trans or cis variety, and thus little or no trans fat content. A mixture of the two fat or oil feedstocks thus can have a fatty acid distribution resembling that of partially hydrogenated soy oil, without the trans fat content which results from partial hydrogenation. The benefits of partial hydrogenation, such as a higher melting range or improved oxidative stability, may be at least partially obtained, in certain embodiments, partially or entirely without the detriment of a substantial increase in trans fatty acid content.

### Soybean Oil

The soybean oil useful in this invention as a starting material can be conventional soybean oil. One typical fatty acid distribution for soybean oil is given by Bunge Foods Typical Fatty Acid Composition Of Selected Fats And Oils as described in Table 1:

TABLE 1
Conventional Soybean Oil Feedstock

| | Fatty Acid | | | |
|---|---|---|---|---|
| | 16:0 | 16:1 | 18:0 | 18:1 |
| % in Conventional Soybean Oil | 10.5 | 0.1 | 3.9 | 22.4 |

| | Fatty Acid | | |
|---|---|---|---|
| | 18:2 | 18:3 | Others |
| % in Conventional Soybean Oil | 54.5 | 7.4 | 0.8 |

The fatty acids identified in the Tables, and some other common fatty acids, are described in Table 2.

TABLE 2
Common Fatty Acids

| Traditional | | No. of Carbon | No. of Double |
|---|---|---|---|
| Name | IUPAC Name | Atoms | Bonds |
| Butyric | Butanoic | 4 | 0 |
| Caproic | Hexanoic | 6 | 0 |
| Caprylic | Octanoic | 8 | 0 |
| Capric | Decanoic | 10 | 0 |
| Lauric | Dodecanoic | 12 | 0 |
| Myristic | Tetradecanoic | 14 | 0 |
| Palmitic | hexadecanoic | 16 | 0 |
| Palmitoleic | cis-9-hexadecenoic | 16 | 1 |
| Stearic | octadecanoic | 18 | 0 |
| Oleic | cis-9-octadecenoic | 18 | 1 |
| Linoleic | cis,cis-9,12- | 18 | 2 |
| | octadecadienoic | | |
| Linolenic | cis,cis,cis-9,12,15- | 18 | 3 |
| | octadecatrienoic | | |
| Eleostearic | cis,trans,trans- | 18 | 3 |
| | 9,11,13- | | |
| | octadecatrienoic | | |
| Ricinoleic | 12-hydroxy-cis-9- | 18 | 1 |
| | octadecenoic | | |
| Arachidic | eicosanoic | 20 | 0 |
| Gadoleic | cis-9-eicosenoic | 20 | 1 |
| Arachidonic | all cis-5,8,11,14- | 20 | 4 |
| | eicosatetraenoic | | |
| Behenic | docosanoic | 22 | 0 |
| Cetoleic | cis-11-docosenoic | 22 | 1 |
| Erucic | cis-13-docosenoic | 22 | 1 |
| Lignoceric | tetracosanoic | 24 | 0 |

In an optional embodiment, the soybean oil feedstock can be a low-linolenic fraction that naturally or by breeding, other genetic modification, or processing has less linolenic acid (which is highly unsaturated, having three sites of unsaturation per fatty acid moiety). A low-linolenic oil is more oxidatively stable than a native soy oil feedstock. One example of a low-linolenic fraction has the constituents and proportions shown in Table 3.

TABLE 3
Low-Linolenic Soybean Oil

| | Fatty Acid Content of | | | |
|---|---|---|---|---|
| | Starting Materials: | | | |
| | C8:0 | C10:0 | C12:0 | C16:0 |
| Low Linolenic Soybean Oil | — | — | — | 9.7 |
| | Fatty Acid Content of | | | |
| | Starting Materials: | | | |
| | C18:0 | C18:1 | C18:2 | C18:3 |
| Low Linolenic Soybean Oil | 4.3 | 25.3 | 56.0 | 2.8 |

In an optional embodiment, the soybean oil includes from 1 to 3.5 wt. %, optionally from 1 to 3.4 wt. %, optionally from 1 to 3.3 wt. %, optionally from 1 to 3.2 wt. %, optionally from 1 to 3.1 wt. %, optionally from 1 to 3.0 wt. %, optionally from 1 to 2.9 wt. %, optionally from 1 to 2.8 wt. %, optionally from 1 to 2.7 wt. %, optionally from 1 to 2.6 wt. %, optionally from 1 to 2.5 wt. %, optionally from 1 to 2.4 wt. %, optionally from 1 to 2.3 wt. %, optionally from 1 to 2.2 wt. %, optionally from 1 to 2.1 wt. %, optionally from 1 to 2.0 wt. %, optionally from 1 to 1.9 wt. %, optionally from 1 to 1.8 wt. %, optionally from 1 to 1.7 wt. %, optionally from 1 to 1.6 wt. %, optionally from 1 to 1.5 wt. %, optionally from 1 to 1.4 wt. %, optionally from 1 to 1.3 wt. %, optionally from 1 to 1.2 wt. %, optionally from 1 to 1.1 wt. %, optionally 1 wt. % linolenic (18:3) fatty acid moieties and from 0 to 2 wt. % trans fatty acid moieties.

### Second Oil

The second oil includes from 90 to 100 wt. % of saturated fatty acid moieties and from 0 to 2 wt. % of trans fatty acid moieties. A few oils, such as coconut oil, have these proportions in nature. One typical fatty acid distribution for coconut oil is given by Kirk-Othmer Encyclopedia of Chemical Technology, 4^{th} Ed., Vol. 10, page 267, in Table 4.

TABLE 4
Conventional Coconut Oil Feedstock

| | Fatty Acid | | | | |
|---|---|---|---|---|---|
| | 6:0 | 8:0 | 10:0 | 12:0 | 14:0 |
| % in Coconut Oil | 0.5 | 8 | 6.4 | 48.5 | 17.6 |
| | Fatty Acid | | | | |
| | 16:0 | 16:1 | 18:0 | 18:1 | 18:2 |
| % in Coconut Oil | 8.4 | — | 2.5 | 65 | 15 |

| | Fatty Acid | | |
|---|---|---|---|
| | 18:3 | 0:0 | 22:0 |
| % in Coconut Oil | — | 0.1 | — |

This particular coconut oil feedstock has 92% saturated moieties. One optional saturated feedstock contemplated here is thus natural coconut oil.

Another option is to use essentially saturated oil of any kind suitable for food use as the second oil. Some representative essentially saturated oils are hydrogenated palm oil, palm kernel oil, a hydrogenated palm oil fraction, a palm kernel oil fraction, a highly hydrogenated soy fat, combinations of any of these, or others. By “essentially saturated” is meant an oil, produced in any way from any source, having from 90 to 100 wt. % of saturated fatty acid moieties and from 0 to 2 wt. % of trans fatty acid moieties. Such oils may be natural oils or partially or fully hydrogenated oils.

Any combination of two or more oils that provides a composition for the second oil having from 90 to 100 wt. % of saturated fatty acid moieties and from 0 to 2 wt. % of trans. fatty acid moieties is also contemplated here.

### Blend of First and Second Oil

The first and second oils can be blended in any suitable proportions to produce a blended oil.

One contemplated shortening blend composition includes from 70 parts to 30 parts by weight of soybean oil comprising from 1 to 3.5 wt. % linolenic fatty acid moieties and from 0 to 2 wt. % trans fatty acid moieties; and from 30 parts to 70 parts by weight of a second oil comprising from 90 to 100 wt. % of saturated fatty acid moieties and from 0 to 2 wt. % of trans fatty acid moieties. A contemplated property of the blend is a trans-fatty acid moiety content of from 0 to 2 wt. %. The two components, or either of them, may have values outside of the contemplated parameters, providing the final product is within the contemplated values given above.

An example of a blend composition of 64.5 wt % TREUS™ and 35.5 wt. % hydrogenated soy fat with an iodine value of 5 centigrams/100 grams is provided in Table 5.

TABLE 5
Blend Composition

| | TREUS ™ | % | TREUS ™ | Std. Soy |
|---|---|---|---|---|
| Species | Formula | TREUS ™ | Weight | Oils |
| stearic(0 C═C) | 16.0% | 64.5% | 10.3% | 15% |
| oleic (1 C═C) | 29.0% | 64.5% | 18.7% | 24% |
| linoleic (2 C═C) | 52.0% | 64.5% | 33.5% | 53% |
| linolenic | 3.0% | 64.5% | 1.9% | 8% |
| (3 C═C) | | | | |
| | 100.0% | | 64.5% | 100.0% |

| | 5 IV Soy | | | |
|---|---|---|---|---|
| | Fat | % 5 IV | 5 IV Soy | Blend |
| Species | Formula | Soy Fat | Fat Weight | Formula |
| stearic(0 C═C) | 100.0% | 35.5% | 35.5% | 45.8% |
| oleic (1 C═C) | 0.0% | 35.5% | 0.0% | 18.7% |
| linoleic (2 C═C) | 0.0% | 35.5% | 0.0% | 33.5% |
| linolenic (3 C═C) | 0.0% | 35.5% | 0.0% | 1.9% |
| | | | 35.5% | 100.0% |

### Interesterified Shortening Composition

The mixture of fat or oil feedstocks can be used directly as a shortening. Optionally, however, the mixture can be interesterified so the fatty acids from each of the respective oil feedstocks are distributed among the entire population of glyceride or fat molecules. An interesterified shortening composition is made by interesterifying from 60 parts to 40 parts by weight of soybean oil comprising from 1 to 3.5 wt. % linolenic fatty acid moieties and from 40 parts to 60 parts by weight of a second oil comprising from 90 to 100 wt. % of saturated fatty acid moieties and from 0 to 2 wt. % of trans fatty acid moieties. A contemplated property of the blend is a trans-fatty acid moiety content of from 0 to 2 wt. %. The two components, or either of them, may have values outside of the contemplated parameters, providing the final product is within the contemplated values given above.

The interesterification and mixing steps can be carried out together or sequentially, without limitation, providing both feedstocks are introduced and combined in some fashion.

Merely mixing the two feedstocks provides many molecules that are characteristic of only one of the two feedstocks. Thus, one has a mixture of glycerides from an unhydrogenated or lightly hydrogenated feedstock, having naturally distributed saturated and unsaturated fatty acid moieties, and glycerides from a highly or fully hydrogenated feedstock, having mostly or entirely saturated fatty acid moieties. This mixture will function as a bimodal mixture to a greater extent than will partially hydrogenated soy fat or oil (which has some fully saturated glycerides and other partially or fully unsaturated glycerides, though fewer polyunsaturated fatty acid moieties, as these are preferentially eliminated by even partial hydrogenation).

If the mixture is interesterified, the fatty aid moieties are believed to be redistributed on the glycerides to form a more nearly statistical or monomodal (or both) distribution of the fatty acid moieties. The chemical interesterification process described below tends to redistribute the fatty acid moieties to a more statistical distribution. The enzymatic interesterification process described below tends to redistribute the fatty acids in a specific pattern. In certain embodiments, the distribution of glycerides is believed to be similar to that of partially hydrogenated oil, with the exception that the oil in some cases may have more polyunsaturated moieties because these have not been preferentially removed by partial hydrogenation.

Matters stated in this specification as being “believed” are based on theory, and are provided to explain why or how the invention is believed to work, but the inventors do not intend to limit the scope of the invention according to the application or accuracy of the theory. All embodiments disclosed are contemplated as exemplary of the invention, whether or not they conform to any theories of the inventors.

Chemical interesterification can be carried out by processing the oil blends previously described using an interesterifying agent such as sodium methoxide. Sodium methoxide can be provided, for example, as a 95% pure powder. One example of suitable interesterification conditions is treatment of the oil blend with 0.15% by weight sodium methoxide at a temperature of about 90° C. (194° F.) at a vacuum of about 75 mm Hg below ambient pressure for about 45 minutes. The treated oil can then be neutralized, as with citric acid, treated with a filter aid such as TRISYL S-615 filter aid, for example at about 91.7° C. (197° F.), filtered to remove soap residue, and bleached to remove color bodies, if necessary.

Enzymatic interesterification can be carried out by processing the oil blends previously described using an interesterifying enzyme. An exemplary enzyme is a lipase. A commercial source of a suitable lipase preparation is Novozymes Lipozyme® TL IM—an immobilized lipase enzyme. Lipozyme is a registered trademark of Novozymes A/S, Bagsvaerd, Denmark. Suitable enzymatic esterification conditions include a reaction temperature of about 68° C. (154° F.) and a reaction rate of about 19 kg interesterified product per 10 kg. enzyme preparation per hour. The oil blend can also optionally be deodorized by heating it to about 237° C. (458° F.) and maintaining that temperature under a vacuum of about 4 mm Hg below ambient pressure, while applying about 0.4 wt % steam per hour, for a time of about two hours.

Interesterification per se, and the catalysts and other conditions to be employed, are well known, as discussed generally in Kirk-Othmer Encyclopedia of Chemical Technology, 4^{th} Ed., Vol. 10, page 263. The complete Kirk-Othmer article, pages 252-287, is incorporated here by reference.

The results of one example of interesterification are shown in Table 6.

TABLE 6
Results of Inter-Esterification

| | Before | After |
|---|---|---|
| Property | Esterification | Esterification |
| Mettler MP, ° C. | 63.8° C. | 46.6° C. |
| SFC* | | |
| 10° C. (50° F.) | 41.17 | 30.20 |
| 21° C. (70° F.) | 37.27 | 20.73 |
| 27° C. (80° F.) | 35.78 | 14.06 |
| 33° C. (92° F.) | 33.42 | 9.70 |
| 40° C. (104° F.) | 29.65 | 6.53 |
| Iodine Value, cg/100 g. | 82.40 | 82.40 |

In Table 6, “SFC” means solid fat content, in percentage of sample, at the indicated temperature.

### Complete Shortening Composition

A complete interesterified or blended shortening composition is defined as consisting essentially of the interesterified or blended shortening composition described above. Such a composition may also contain other constituents, such as other oils, emulsifiers, anti-oxidants, or other stabilizers. While other additives are not common, additional additives such as coloring, flavoring, nutritional supplements, etc. can be used if desired.

### Product

Still another aspect of the invention is a product consisting essentially of the complete interesterified or blended shortening composition described above. Several non-limiting examples of the product are a baked good, such as a short bread cookie, biscuit, pie crust, or puff pastry shell, or an icing.

The baked goods may contain even a predominant proportion of other constituents, for example, flour, sugar or other sweeteners, egg or egg products, milk or milk products such as cream, whipped cream, butter, buttermilk, cream cheese, etc., emulsifiers such as mono- and diglycerides, flavorings such as vanilla or almond extracts, cocoa, cinnamon, coconut, fruit, water, salt, icing, and other ingredients, without limitation.

The icing may contain other constituents, for example, sugar or other sweeteners, egg or egg products, milk or milk products such as cream, whipped cream, butter, buttermilk, cream cheese, etc., emulsifiers such as mono- and diglycerides, flavorings such as vanilla or almond extracts, cinnamon, cocoa, coconut, fruit, water, salt, and other ingredients, without limitation.

### WORKING EXAMPLES

In working examples 1, 2, and 3, identified in Table 7, soybean oil and soy fat were blended or interesterified to make shortening. Example 1 is a blended composition. Working Example 2 was enzymatically interesterified. Working Example 3 was chemically interesterified.

In comparative examples A, B, and C, also identified in Table 7, conventional shortening compositions were provided. Comparative Example A is a non-hydrogenated palm oil shortening. Comparative Example B is a low-trans hydrogenated soybean oil shortening. Comparative Example C is a high trans fatty acid partially hydrogenated soybean oil control composition.

TABLE 7
Shortening Comparison Table
ENZ IE8-fatty acid composition is base on regular FAME. Not Nutritional
numbers.

| | EXAMPLE | | | | | |
|---|---|---|---|---|---|---|
| | | | | Comp. | Comp. | Comp. |
| | Ex. 1 | Ex. 2 | Ex. 3 | Ex. 4 | Ex.. B | Ex. C |
| Application | Soft AP | AP | AP | AP | AP | AP |
| IV, cg/g | 102.0 | 82.4 | 82.0 | 47.0 | 105.0 | 76.0 |
| MDP, | 35.56 | 46.67 | 46.67 | 45.56 | 53.89 | 48.89 |
| ° C., (° F.) | (96.0) | (116.0) | (116.0) | (114.0) | (129.0) | (120.0) |
| SFC, −12.2° C. | 21.0% | 30.2% | 30.0% | 61.0% | 23.0% | 43.0% |
| (10° F.) | | | | | | |
| SFC, −6.06° C. | 13.0% | 20.7% | 19.0% | 36.0% | 19.0% | 26.0% |
| (21.1° F.) | | | | | | |
| SFC, −2.94° C. | 9.0% | 14.1% | 14.0% | 23.0% | 17.0% | 19.0% |
| (26.7° F.) | | | | | | |
| SFC, 0.72° C. | 5.0% | 9.7% | 10.0% | 14.0% | 15.0% | 14.0% |
| (33.3° F.) | | | | | | |
| SFC, 4.4° C. | 1.0% | 6.5% | 5.0% | 9.0% | 12.0% | 8.0% |
| (40° F.) | | | | | | |

| | Limited | Limited | Limited | Limited | Limited | |
|---|---|---|---|---|---|---|
| FAME | Data | Data | Data | Data | Data | Full Data |
| C4 | — | | — | — | — | — |
| C6 | — | | — | — | — | — |
| C8 | 0.11 | | — | 0.03 | — | — |
| C10 | 0.17 | | — | 0.02 | — | — |
| C11 | — | | — | — | — | — |
| C12 | 3.45 | | 0.01 | 0.18 | 0.01 | 0.01 |
| C14 | 1.62 | 0.08 | 0.15 | 0.99 | 0.15 | 0.15 |
| C14:1 | — | — | — | — | — | — |
| C15 | 0.02 | | 0.03 | 0.05 | 0.02 | 0.02 |
| ISO C16 | 0.02 | | 0.01 | — | 0.02 | 0.02 |
| C15:1 | 0.01 | | 0.01 | — | 0.01 | 0.02 |
| C16 | 19.06 | 10.16 | 11.15 | 42.82 | 11.33 | 11.31 |
| C16:1T | — | | — | — | — | — |
| C16:1 | 0.09 | 0.06 | 0.10 | 0.16 | 0.09 | 0.08 |
| C17 | 0.10 | | 0.14 | 0.10 | 0.12 | 0.11 |
| C17:1 | 0.04 | | 0.03 | 0.02 | 0.04 | 0.04 |
| C18 | 4.41 | 32.27 | 29.53 | 4.52 | 14.67 | 12.61 |
| C18:1T | 0.13 | 0.17 | 1.26 | 0.47 | 3.02 | 18.83 |
| C18:1 | 20.02 | 16.82 | 14.83 | 34.21 | 21.68 | 35.61 |
| C18:2T | 0.21 | 0.26 | 0.21 | 0.37 | 1.28 | 4.50 |
| C18:2 | 41.96 | 36.66 | 30.76 | 9.21 | 35.39 | 8.33 |
| C20 | 0.32 | 0.41 | 0.37 | 0.35 | 0.33 | 0.35 |
| C18:3T | 0.13 | 0.21 | 0.20 | 0.10 | 0.43 | 0.19 |
| C20:1 | 0.14 | 0.12 | 0.09 | 0.12 | 0.14 | 0.14 |
| C18:3 | 1.75 | 1.87 | 3.72 | 0.23 | 4.37 | 0.19 |
| C18:2 conj | 0.06 | | 0.05 | 0.03 | 0.06 | 0.13 |
| C20:2 | 0.03 | | 0.02 | — | 0.02 | — |
| C22 | 0.28 | 0.36 | 0.30 | 0.07 | 0.31 | 0.32 |
| C20:3 | — | | — | — | — | — |
| C22:1 | — | 0.04 | — | — | — | — |
| C20:4 | — | | — | — | — | — |
| C23 | 0.03 | | 0.03 | 0.02 | 0.04 | 0.04 |
| C20:5 | — | | — | — | — | — |
| C24 | 0.10 | 0.11 | 0.10 | 0.06 | 0.10 | 0.12 |
| C24:1 | — | | — | — | — | — |
| Sum unk | 0.02 | | 0.03 | 0.02 | 0.08 | 0.12 |
| Total | 98.69 | 99.60 | 97.36 | 98.60 | 97.98 | 97.47 |
| Sat'd. FA | 29.69 | 43.41 | 41.81 | 49.21 | 27.10 | 25.06 |
| PUFA | 43.80 | 38.53 | 34.55 | 9.47 | 39.85 | 8.65 |
| Trans | 0.47 | 0.64 | 1.67 | 0.94 | 4.73 | 23.52 |
| Mono | 20.30 | 16.84 | 15.07 | 34.52 | 21.96 | 35.88 |

To determine the proportions of individual fatty acids in Working Examples 1-3 and Comparative Examples A-C, the fatty acids™ were stripped from the corresponding triglycerides and converted to fatty acid methyl esters. The proportion of each fatty acid methyl ester constituent was determined; the results are shown in Table 7. The individual proportion of each methyl ester is shown in part 2 of the table; test results and the sum of each type of fatty acid constituent is shown in part 1 of the table. The trans fatty acid fractions are indicated in Table by the letter “T” in the identification of the fatty acid. For example, C16:1T is the amount of C16 monounsaturated trans fatty acid (e.g. trans-palmoleic acid), while C16:1 is the amount of C16 monounsaturated cis fatty acid (e.g. cis-palmoleic acid). The fatty acid constituents were reported as the weight of the corresponding methyl esters.

In Table 7, “AP” means all-purpose, “IV” means iodine value in centigrams per 100 grams (cg/100 g), “MDP” means Mettler drop point, ° C. and OF, “SFC” means solid fat content, “Sat'd. FA” means saturated fatty acid, “PUFA” means polyunsaturated fatty acid, “Trans” means trans fatty acid, “Mono” means monounsaturated fatty acid “FAME” means fatty acid methyl ester, and “sum unk” means material having an unknown composition.

### All Purpose Shortening Testing

Various baked goods and icings were made using shortenings that had been processed using chemical or enzymatic interesterification. These test shortenings were evaluated versus control shortening (made by partial hydrogenation).

An attempt was made to standardize variables other than the shortening being evaluated. All shortening and major dry ingredients were tempered to room temperature before beginning testing. Mixing instructions, bake times and temperatures were held constant for all baked goods, except where the experimenter's professional opinion was that adjustments were needed to make acceptable products. These modifications are noted in the observations below.

### Wet Cream

A wet cream test was conducted on the shortenings of Working Examples 1-3 and Comparative Examples A-C. A wet cream test is carried out to determine the ability of shortening to cream or entrain air, measured by determining the specific gravity of each wet cream composition. A greater ability to entrain air, thus a lower specific gravity, indicates superior performance in this test. The results of testing are summarized in Table 8.

TABLE 8
Wet Cream

| | Sp | Scoring | | |
|---|---|---|---|---|
| Example | G(g/cm³⁾ | Format | Trench | Smoothness |
| Working 1 | | | | |
| Working 2 | 0.579 | L | A | L |
| Working 3 | 0.515 | H | VA | H (excellent) |
| Compar A | 0.655 | M | A | M |
| Compar B | 0.550 | | A | M |
| Compar C | 0.630 | M | A | M |

H = better than others scored
L = worse than others scored
M = middle (between H and L)
A = acceptable
VA = very acceptable

After 25 minutes of mixing, the Final Specific Gravities (SpG) of the wet cream made with Comparative Example C and Comparative Example A were fairly similar, (0.630 vs. 0.655 g/cm³), while the Comparative Example B wet cream had a significantly lower final SpG at 0.550 g/cm³, indicating better creaming capabilities vs. the other control shortenings.

The Working Example 3 wet cream had the lowest final SpG (at 0.515 g/cm³) of all shortenings tested, indicating the best ability to cream air. The wet cream made with Working Example 2 had a lower SpG at 0.579 g/cm³ vs. Comparative Example C and Comparative Example A, but not as low as Comparative Example B.

Differences in the shortenings' rate of air incorporation were also noted. After five minutes of mixing, all other wet creams had less incorporated air than Comparative Example C shortening. After 15 minutes of mixing, however, Comparative Example B and Working Example 2 and 3 wet creams had incorporated more air than the Comparative Example C shortening wet cream.

The wet cream made with Working Example 3 was judged to have the best score based on the wet cream scoring format, which combines mouth feel and smoothness, while the wet creams made with Comparative Examples C and A were judged to be equal to each other in score and have the second best score. The wet cream made with Working Example 2 was judged to have the least acceptable score.

The wet creams were trench scored by forming a trench in the wet cream and seeing how long (in seconds) the trench was maintained without collapsing. A trench score test is one evaluation of the smoothness of the wet cream; a higher score indicates a smoother icing. All the wet creams were judged to have acceptable trench scores. The wet cream made with Working Example 3 was judged to be very acceptable, thus better than the others.

In the smoothness score, the wet cream made with Working Example 3 was judged to be excellent. The wet cream made with Comparative Example B was judged second best, followed closely by the wet cream made with Comparative Example A. The wet cream made with Working Example 2 was judged to be less desirable than the other wet creams.

Other observations noted included the following. An objectionable, rancid, off-flavor was noted in the shortening and wet creams made with Working Example 2. Comparative Example B was off-white in color and waxy/oily in appearance.

### Oven Heat Test

Resistance to darkening was measured for the following shortenings, Comparative Example C, Comparative Example B, Comparative Example A, Working Example 3, Working Example 2, and Working Example 1 shortenings using analytical and color tube methods. One hundred grams of each shortening were placed in a 600 ml. beaker and heated at 400° F. (204° C. A small sample was taken each hour and analyzed for color development. Both types of color analysis showed that the Working Example 1 composition darkened the least.

### Sugar Cookie

A sugar cookie formula chosen from the Food Service Online bakery formula data base was used to prepare cookies using Comparative Example C, Comparative Example A, Working Example 3, and Working Example 2 shortenings. Comparative Example B was not used to prepare sugar cookies. The results of testing are summarized in Table 9.

TABLE 9
Cookie

| Example | Spread (cm) | Stock (cm) | Texture |
|---|---|---|---|
| 1 | | | |
| 2 | L (49.5) | H (7.3) | M |
| 3 | M | M | H (soft) |
| A | H (47.77) | M | L (firm) |
| B | | | |
| C | M | L (6.06) | M |

The cookie dough appearance and handling characteristics for all shortening variables were similar, like or equal to the cookie dough made using Comparative Example C. Also, the cookie dough made with Comparative Example A was judged to be more fine, drier, and more difficult to roll out than the cookie dough made using Comparative Example C.

Three cookies made with each shortening were placed side by side to measure spread. To compensate for cookie irregularities, the same three cookies were measured three times and the average of the three readings was recorded in centimeters as the spread. This was repeated for each shortening variable. Using this technique, the cookies exhibiting the most spread were the cookies made with Working Example 2; and the cookies exhibiting the least spread were those made with the Comparative Example A at 47.77 cm.

All the types of cookies were also measured for height by stacking four cookies made with each shortening on top of one another and measuring and recording the total height. This procedure was repeated three times and the results averaged and recorded. The highest stacked height noted was for the cookies made with the shortening of Working Example 2 at 7.3 cm, while the shortest stacked height was from the cookies made with Comparative Example C at 6.06 cm.

The texture of the sugar cookies was evaluated using a texture analyzer the following day. The cookies made with Comparative Example A were the firmest, while the cookies made with Working Example 3 were the softest.

Other observations noted included the following. Except biscuits made with Comparative Example A, all the shortenings mixed in about 1 min after the flour was added. Also, all the dough developed a pinkish beige off color after it was held overnight.

### Biscuits

Baking Powder biscuits were made with Example 1 and Comparative Example C shortenings, using a formula from the Food Service Online bakery formula database. Although this formula called for milk, buttermilk was substituted, one for one, in each dough. The results of testing are summarized in Table 10.

TABLE 10
Baking Powder Biscuit

| Example | Lump Size | Spread (cm) | Height (cm) |
|---|---|---|---|
| 1 | | | |
| 2 | L | H | H |
| 3 | L | H | H |
| A | H (biggest) | L (48.33) | L (19.43) |
| B | L | H | H |
| C | L | H | H |

All other shortenings tested produced shortening lumps that were similar to the biscuit dough made with Comparative Example C.

The finished biscuit doughs made with Comparative Example B and Working Example 2 were judged to be similar to the biscuit dough made with Comparative Example C. The biscuit dough made with Comparative Example A was judged to be firmer and drier than the biscuit dough made with Comparative Example C, but it rolled out satisfactorily. The Working Example 3 dough was judged to be soft, but not sticky.

Baked Biscuit height was determined in the same manner as with the sugar cookies. The biscuits with the least height were made with Comparative Example A at 19.43 cm.

Other observations noted Included the following. All the biscuit dough turned pinkish beige after setting overnight at room temperature.

### Shortbread:

Shortbread cookies were made with Comparative Example C and Working Example 1, using a formula from the Food Service Online bakery formula database. The results of testing are summarized in Table 11.

TABLE 11
Shortbread

| Example | Shortness | Texture | Spread | Height |
|---|---|---|---|---|
| 1 | Excellent | H (softer) | H (less) | L |
| C | | L | L | H (higher) |

The shortbreads all were judged to exhibited excellent shortness.

The textures of all of the baked shortbreads were judged subjectively to be very tender. Using the TA-XT2 texture analyzer the shortbread made with Working Example 1 was softer than the shortbread made with Comparative Example C.

Spread, as measured using the same technique as the sugar cookies, showed that Working Example 1 produced shortbread with directionally less spread than the shortbread made with Comparative Example C.

Shortbread height was measured by the same technique used with the sugar cookie and both test shortening shortbreads were slightly less in height than the shortbread made with Comparative Example C.

### Pie Dough

Pie doughs were made using a formula from the Food Service Online bakery formula data base with the following shortenings, Comparative Example C, Comparative Example B, Comparative Example A, and Working Examples 2 and 3. The doughs were made in the morning and allowed to hydrate in the retarder until the afternoon before handling, makeup and baking. Mix times were varied slightly during the first stage cutting in of shortening and the water addition stage during mixing in an attempt to standardize the size of the shortening lumps in the dough. The results of testing are summarized in Table 12.

TABLE 12
Pie Dough

| Example | Height (cm) |
|---|---|
| 2 | H (3.8) |
| 3 | |
| A | |
| B | L (3.0) |
| C | |

All the doughs were judged to be acceptable to work with, except the Comparative Example A dough, which was very difficult to handle after chilling.

All the baked pie dough was judged to be flaky and short.

Pie dough height was measured by stacking three sheets of baked pie dough. Pie dough made with Comparative Example B was the shortest at 3.0 cm, and the baked pie dough made according to Working Example 2 was the tallest at 3.8 cm.

### Summary of Results

Generally, the enzymatically and chemically interesterified test shortenings (Working Examples 2 and 3) made acceptable sugar cookies, biscuits and pie doughs. Because of its firmness, Comparative Example A was difficult to work with in pie doughs, but the resulting baked pie dough was flaky and short.

In the wet cream test, Working Examples 2 and 3 creamed in air better than the controls (comparative examples).

There were appearance and fineness differences noted in several of the test shortenings and resulting doughs. It appears that the differences are such that they should be able to be overcome with some slight handling modification by the baker.

Off colors were noted in many of the doughs made with the test shortenings. In some of the baked goods, such as biscuits or cookies, where bakers may hold the dough under refrigeration or freeze it for extended periods of time, this may be an issue.

Off flavor was noted in Working Example 2 and the resulting wet creams. However, the peroxide values of the enzymatic interesterified shortening did not show the shortenings to be higher than control or normal for shortenings of the same age.

### Emulsified Shortening Testing:

Cream icing was made with Comparative Examples A-C and Working Examples 2 and 3. 3.7 percent of Vrest Plus™ mono/diglyceride emulsifier was added to each shortening by melting the emulsifier and adding it to the shortening with hand mixing and then by mixing in the mixer for a short time (approximately 1 minute) before beginning to add the other ingredients. The results of testing are summarized in Table 13.

TABLE 13
Emulsified Shortening

| Cream Icing | Sp G(g/cm³⁾ | Trench | Buskometer |
|---|---|---|---|
| 2 | M | L (<5) | L |
| 3 | H (.802) | M (6–15) | L |
| A | H (.800) | H (>61) | H |
| B | L (1.014) | | L |
| C | M (0.842) | M (16–30) | H |

The cream icing made with Comparative Example C had a SpG of 0.842 g/cm³. Cream icings made with Comparative Example A and Working Example 3 were slightly lighter than the Comparative Example C cream icing at 0.800 and 0.802 g/cm³. Cream icing made with Working Example 2 was heavier than the Comparative Example C cream icing at 0.855 g/cm³, while the cream icing made with Comparative Example B was much heavier and did not cream any air, resulting in a SpG of 1.014 g/cm³.

Trench test results showed the Comparative Example A cream icing having the best trench test results at greater than 61 seconds before collapsing, while the Working Example 2 cream icing trench collapsed within 5 seconds. The Working Example 3 cream icing trench collapsed within 6 to 15 seconds, while the Comparative Example C cream icing trench stayed open for 16 to 30 seconds.

All cream icings were judged to be smooth with small air cells, except the cream icing made with Working Example 3, and that icing was judged to be slightly smooth with medium air cells.

Icing body was gauged by a slump test referred to as a Buskometer test. The cream icings made with Comparative Example C and Comparative Example A were similar to each other, while cream icings made with all other shortening samples slumped and compressed more than the Comparative Example C and Comparative Example A cream icing.

Other observations noted Included the following. Comparative Example B cream icing was described as runny, while the Comparative Example A cream icing exhibited no bowl slide. Comparative Example C cream icing was described as having small or some bowl slide, while Working Examples 2 and 3 were described as having more bowl slide than the Comparative Example C cream icing. The Working Example 3 shortening was seen to have a peach colored appearance.

Comparative Example A+emulsifier produced a better cream icing than the Comparative Example C+emulsifier control, while Comparative Example B produced an unacceptably soft and heavy cream icing. The other shortening samples produced acceptable cream icings.

Off color was noted in the cream icing made with Working Example 3.

What is claimed is:

1. An interesterified shortening composition made by interesterifying:
a. from 60 parts to 40 parts by weight of soy oil comprising from 1 to 3.5 wt. % linolenic fatty acid moieties and from 0 to 2 wt. % trans fatty acid moieties; and
b. from 40 parts to 60 parts by weight of a second oil comprising from 90 to 100 wt. % of saturated fatty acid moieties and from 0 to 2 wt. % of trans fatty acid moieties;
wherein:
c. the interesterified product has a trans-fatty acid moiety content of from 0 to 2 wt. %;
d. the weight % of each fatty acid moiety is expressed as the corresponding weight of a fatty acid methyl ester moiety; and
e. the basis of each weight percentage of moieties in an oil is the total weight of all fatty acid moieties in the oil, expressed as the corresponding weight of fatty acid methyl ester moieties.

2. The interesterified shortening composition of claim 1, in which the second oil comprises essentially saturated oil.

3. The interesterified shortening composition of claim 1, in which the second oil comprises palm oil, palm kernel oil, a palm oil fraction, a palm kernel oil fraction, or a combination of those.

4. A complete interesterified shortening composition consisting essentially of the interesterified shortening composition of claim 1.

5. A product consisting essentially of the complete interesterified shortening composition shortening composition of claim 4.

6. The product of claim 5, which is an icing.

7. The product of claim 5, which is a baked good.

8. The product of claim 7, which is a short bread cookie, biscuit, pie crust, or puff pastry shell.

9. The product of claim 7, which is a short bread cookie.

10. The product of claim 7, which is a biscuit.

11. The product of claim 7, which is a pie crust.

12. The product of claim 7, which is a puff pastry shell.

13. A shortening blend composition comprising:
a. from 70 parts to 30 parts by weight of soy oil comprising from 1 to 3.5 wt. % linolenic fatty acid moieties and from 0 to 2 wt. % trans fatty acid moieties; and
b. from 30 parts to 70 parts by weight of a second oil comprising from 90 to 100 wt. % of saturated fatty acid moieties and from 0 to 2 wt. % of trans fatty acid moieties;
c. the soy oil and second oil in the composition together having a trans-fatty acid moiety content of from 0 to 2 wt. %;
d. the wt. % of each fatty acid moiety being expressed as the corresponding weight of a fatty acid methyl ester moiety; and
e. the basis of each weight percentage of moieties in an oil being the total weight of all fatty acid moieties in the oil, expressed as the corresponding weight of fatty acid methyl ester moieties.

14. The shortening blend composition of claim 13, in which the second oil comprises essentially saturated oil.

15. The shortening blend composition of claim 13, in which the second oil comprises palm oil, palm kernel oil, a palm oil fraction, a palm kernel oil fraction, or a combination of those.

16. A complete shortening composition consisting essentially of the shortening blend composition of claim 14.

17. A product consisting essentially of the complete shortening composition of claim 16.

18. The product of claim 17, which is an icing.

19. The product of claim 17, which is a baked good.

20. The product of claim 19, which is a short bread cookie, biscuit, pie crust, or puff pastry shell.
